(19) United States
(12) Patent Application Publication
(10) Pub. No.: US 2021/0340975 A1
(43) Pub. Date: Nov. 4, 2021

(54) METHOD FOR INCREASING THE EFFICIENCY OF HERMETIC COMPRESSORS USED IN REFRIGERATION AND AIR CONDITIONING

(71) Applicant: TECUMSEH DO BRASIL LTDA., SÃO CARLOS (BR)

(72) Inventors: Mario Luis Botega, JR., SÃO CARLOS (BR); William Cesar De Andrade Pereira, SÃO CARLOS (BR)

(73) Assignee: TECUMSEH DO BRASIL LTDA., SÃO CARLOS (BR)

(21) Appl. No.: 17/286,579

(22) PCT Filed: Oct. 18, 2019
(86) PCT No.: PCT/BR2019/000031

§ 371 Date: Apr. 19, 2021

(30) Foreign Application Priority Data
Oct. 19, 2018 (BR) 1020180715577

(51) Int. Cl. F04B 49/06; F04B 35/04; F04B 49/20; H02P 21/20; H02P 21/02

(52) U.S. Cl. CPC F04B 49/065; F04B 35/04; F04B 49/20; F04B 2203/0209; H02P 21/02; F04B 2203/0201; F04B 2203/0202; H02P 21/20

(57) ABSTRACT

The present invention relates to a speed control system for hermetic compressors of the variable speed type, which uses a PMSM motor, containing a strategy for optimization, or minimization, of the electric current. Once the minimum current has been defined to meet a given demand for torque, it is applied to the hermetic compressor motor, which will operate at the maximum efficiency point for each load point.

### BACKGROUND

The present invention relates to a method for increasing the efficiency of hermetic compressors, applied in refrigeration systems and air conditioners, both in static and mobile applications, and more specifically for those compressors that use magnet synchronous electric motors permanent in the rotor.

The aforementioned compressor operating with a motor with permanent magnets on the rotor requires electronic activation, to guarantee the synchronism between the mechanical position of the rotor and the electrical stator excitation signal. On the other hand, in a hermetically sealed compressor, there is no access to the rotor to determine its angular position; therefore, techniques without a position sensor should be used, in order to eliminate the need for coupling to the motor axis of said sensors. In addition to the sensorless technique, high-efficiency drives require the use of high-performance control strategies, such as vector control, in which their concepts were first introduced by K. Hasse in 1969 and unified by F. Blaschke in 1972.

The said motor with permanent magnets on the rotor is a good alternative for hermetic compressors, due to the torque per ampere ratio, torque per volume, wide range of operating speed and greater efficiency when compared to induction motors.

The present invention makes use of the vector control technique without a mechanical speed sensor, for motors with permanent magnet in the rotor applied in hermetic compressors, coupled with an algorithm to minimize the current applied to the motor, which determines the lowest current for a given engine load point. By activating the hermetic compressor through this technique, the current drained from the electrical network is reduced, the compressor efficiency is increased and the lowest possible energy consumption is obtained for a given operating condition.

As is well known in the prior art, refrigeration equipment and air conditioners have a plurality of electromechanical or electronic devices to command the operation of the hermetic compressor, responsible for pumping the refrigerant fluid in such equipment. Among these equipment and air conditioners, a special category uses hermetic compressors of variable capacity, which allow varying the cooling capacity depending on the thermal load, for any moment of operation. The possibility of varying the thermal capacity is particularly interesting when it is desired to reduce the consumption of electrical energy, since once the thermal load of a given refrigeration equipment, or the ambient temperature controlled by an air conditioner, has reached the adjusted reference, you can reduce the refrigerating capacity of the compressor, which will operate in a steady state only to replace the thermal losses of the system. From the current technique it is known that the cooling capacity developed by a hermetic compressor is directly proportional to the consumption of electrical energy; thus, the lower the cooling capacity required by the thermal load, the lower the energy consumption and vice versa.

From the current technique it is known that the cooling capacity developed by a hermetic compressor is directly proportional to the rotation speed of the electric motor; thus, the higher the speed, the greater the cooling capacity, however, the energy consumption from the power grid will also be greater.

The hermetic compressor for variable speed applications is composed, from an electrical point of view, basically by the following components: electric motor, electronic converter (responsible for converting alternating voltage into direct voltage and direct voltage into alternating voltage), filters and system digital signal processing. From these components, the speed of the electric motor is controlled by means of an electronic converter (typically a three-phase converter), which uses an appropriate software logic, implemented in its digital signal processor, in order to generate electrical voltages with magnitude, frequency and phase controlled to be applied to the terminals of the electric motor.

The efficiency of a hermetic compressor is related to mechanical, electrical, and thermodynamic aspects. However, the electric motor represents a large part of the overall efficiency of the compressor. For this reason, the use of permanent magnet motors in the rotor in hermetic compressors is justified by two main characteristics: high efficiency and high power density. These two factors are directly related to the fact that no electric current circulates in the rotor of permanent magnet motors. Thus, this type of motor does not present the following losses: ohmic losses in the rotor, losses due to magnetization, mechanical losses (due to the commutator), among others.

The permanent magnet motors in the rotor can be constructively classified according to the arrangement of their permanent magnets, and can be, in general, on the surface or inserted in the steel package of the rotor.

In addition to the classification by constructive topology, the permanent magnet motors in the rotor can also be classified according to the waveform of the force against electromotive force (FCEM) induced in the phases of the windings located in the stationary part of the motor construction by the magnets permanent, and can be sinusoidal or non-sinusoidal. In general, the non-sinusoidal waveform approaches a trapezoidal shape.

Usually, in the literature and in industrial environments, synchronous motors with permanent magnet in the rotor and sinusoidal FCEM are simply called permanent magnet synchronous motors (PMSM). On the other hand, the synchronous motors with magnet on the rotor and trapezoidal FCEM, normally marketed together with electronic power converter, are generally called or known as brushless DC (BLDC). It is worth noting that this type of motor, together with the inverter, originated from the proposal to design a traditional direct current motor, but without the use of carbon brushes and mechanical commutator.

Regarding the principle of operation, both PMSM and BLDC, work in a similar way to the classic synchronous motor, in which the magnetic field of the rotor oscillates with the same frequency as the electrical speed of the rotor. In other words, magnetic flux and electrical speed of the rotor are synchronized. However, unlike PMSM and BLDC, in the classic synchronous motor, the magnetic flux in the rotor is imposed by an external power supply, resulting in less efficiency.

The mechanical conjugate produced in the PMSM is the result of the interaction between the electric current that circulates in the stator windings and the magnetic flux present in the rotor. However, to produce a suitable mechanical conjugate, the electrical voltage applied to the stator windings of permanent magnet motors need to be controlled, and this is achieved based on some principles.

It is well known that the control of the electrical voltage applied to the motor terminals can be done in a simple way in the BLDC, through a method known as six steps. This specific method is characterized by: low dependence on the electrical parameters of the motor, such as inductances and electrical resistances, and the demand for less computational capacity from the digital signal processing stage. However, due to the limitations of the semiconductor components that make up the electronic converter, the six steps strategy has limited performance in practical applications. Therefore, in general, it is used only in applications that require low performance in a transient and permanent regime. On the other hand, when activating the PMSM it is possible to use methods that provide high dynamic performance and high efficiency. As previously mentioned in this document, “vector control” or also known as “field oriented control” (FOC) is the most widespread method of controlling electric motors in the industry, being used by large companies in the segment of driving electric machines.

The FOC was the first strategy that allowed high dynamic performance to be controlled in three-phase motors. Developed in the 1970s by F. Blashke, the FOC has become increasingly popular over time. With this strategy, the control system can be simplified by decoupling the electrical quantities that act on the flow and electromagnetic torque of the motor, resulting in a similar scheme to the control of the DC motor with independent excitation. The most characteristic aspect of the FOC is the decomposition of the stator current into two components that are oriented in the synchronous coordinate system. With the use of FOC, the non-linear and highly coupled dynamics of a three-phase motor can be treated to become linear and decoupled, facilitating the design of the control system.

In a process in which the electric motor must operate at variable speed and with high precision of the control system, it is necessary to obtain the information of the angular position of the rotor at each sampling period of the control system. Usually, electromechanical sensors (encoders or generators) can be used to obtain this type of information. However, in processes that use hermetic compressors, this type of solution is not possible. This is due to construction limitations of this type of compressor and other issues related to the cost of the equipment. As an alternative to mechanical sensors, speed estimation strategies typically known as sensorless are generally used, together with the FOC control method.

Sensorless control strategies use the mathematical model of the electric motor and measurements of electrical quantities (voltage on the DC bus and motor currents) to estimate the speed of the rotor. In a system with electronic control of the hermetic compressor, both the execution of the FOC control and the sensorless method are integrated into the electronic converter.

Electronic converters intended to drive hermetic compressors, applied in refrigeration systems and air conditioners, typically measure only the current on the DC bus (after the filter for eliminating the pulse from the rectifier), with the current applied to the motor being rebuilt from that DC current; this eliminates the need for isolated sensors for three-phase currents.

Three-phase currents are input for the FOC control and for the speed estimation method. However, using a three-phase model of an electric motor (PMSM or BLDC, for example) would result in an extremely complex control system. Therefore, one of the great advantages of the FOC method is to use the transformations of Clarke and Park to simplify the control system. Using the aforementioned transformations, it is possible to replace the three-phase AC model that represents the motor (PMSM or BLDC) by a two-phase model in synchronous reference, that is, in which the electrical and magnetic quantities have continuous behavior.

From the reconstruction of the phase currents of the motor by means of the DC current, as is well known in the current technique, applying the transformations of Clarke and Park in these currents, two new currents are obtained: a current called axis direct (i_{d}) and another current called quadrature axis (i_{q}), aligned in the synchronous frame.

The FOC control strategy has a specific action on the direct axis and quadrature axis currents, in order to achieve the torque required by the load coupled to the motor shaft. However, there are an infinite number of possible combinations of i_{d} and i_{q} to produce the same required conjugate. Thus, it is possible to optimize the choice of these components in order to achieve some operating requirements, such as the maximum efficiency of the PMSM.

The choice of the combination of i_{d} and i_{q} that optimally minimizes PMSM losses and consequently makes the motor operate with high efficiency can be obtained through the method known as maximum torque per ampere (MTPA).

With MTPA, PMSM achieves optimum performance by making use of the magnetic density of the permanent magnet and the effect of magnetic reluctance due to the arrangement of the magnetic material in the rotor.

The use of the FOC together with the MTPA technique produces significant efficiency gains for the hermetic compressor, especially when its performance is compared with the six-pulse drive.

Most recent electronic converters for refrigeration equipment and air conditioners consider the use of the MTPA technique for several purposes, as described in the patents: U.S. Pat. No. 9,695,820 B2 and US2014/0044562 A1, which describe a control system for a compressor based on the measurement of oil and current temperature to maximize efficiency; however, such a solution requires the inclusion of two temperature sensors in the compressor that make the product more expensive. Chinese patents CN107013447 and CN106968931 apply this technique to address aspects related to noise, vibration, and speed fluctuation in compressors; the Chinese patent CN104378037 considers the MTPA technique in the operation of compressors at low speed and high load, applied in air conditioners, however it is known that, in refrigeration systems and air conditioners operating with variable speed compressors, the low condition speed and high load does not occur under normal conditions in the application; the Korean patent KR20140108956 describes a proposal to minimize the current of the DC bus applied in air conditioners; the Korean patent KR20140096626 addresses the reduction of the capacitor of the DC bus and increase of the power factor at the inverter output to reduce the harmonic content; the Chinese patent CN106788074 aims to solve the problem of the low accuracy of the measurement and calculation of the id current, so that the MTPA algorithm can be used with greater precision; the Chinese patent CN104601075 minimizes the output power of the electronic converter by operating the compressor at low speeds; and the Chinese patent CN106452243 explores the field weakening strategy in a PMSM to reduce speed fluctuation.

In addition to the patents that apply the MTPA technique to drive hermetic compressors with synchronous motors with permanent magnet on the rotor, several other patents explore different approaches to the use of MTPA in PMSM, but not directly related to the activation of hermetic compressors, as described in the patents: BR 11 2013 022024 4 A2 and U.S. Pat. No. 8,410,737 B2 that describe a method to generate the initial operation points of the MTPA algorithm through a table, thus avoiding the analytical solution of the equations that make up the aforementioned algorithm; U.S. Pat. No. 8,648,555 B2 describes a method and system for controlling an engine to obtain a constant torque condition; Chinese patent CN102223133 explores MTPA's characteristic of generating maximum torque when applied to a permanent magnet motor with protruding poles; Chinese patents CN106533305, CN106712631 and CN106712630 address the use of the field weakening technique in the condition that id is unstable due to fluctuations in the mains voltage, addressing the problem of id variation and ensuring the operation of the field weakening during the transitional network; Chinese patents CN106533309 and CN106533306 use the field weakening technique with maximum efficiency, even operating in the over modulation condition; Chinese patent CN104935232 deals with the use of the MTPA technique in conjunction with direct conjugate control, typically known as Direct Torque Control (DTC); the Chinese patent CN105262394 uses the MTPA technique in PMSM for discrete speed points, obtaining high efficiency only for these operation points and the Chinese patent CN107707166 reports the invention of a control strategy with self-learning, applied in a PMSM and using MTPA to obtain maximum conjugate availability.

Even considering the great variety of solutions involving the use of PMSM combined with the MTPA algorithm and applied in hermetic compressors of variable capacity, the current techniques have limitations or particularizations that the present invention proposes to solve, mainly the one involving the increase of the overall efficiency of the hermetic compressor, i.e. over the entire operating speed range.

### SUMMARY

It is therefore the purpose of the current invention to provide a control strategy applied to hermetic compressors of variable speed, which use permanent magnet synchronous motors in the rotor, by means of the FOC technique with MTPA coupled, optimizing the operation over the entire range of compressor speed.

In line with the first objective, it is a second objective to define a method of searching for the lowest current necessary to develop the conjugate required by the thermal load of the cooling systems or the air conditioner and, in this way, to reduce the ohmic losses of the engine, reduce the operating temperature of the compressor and thereby maximize the efficiency of the engine and increase the thermodynamic efficiency of the compressor. This method takes into account several parameters of the motor such as: inductances, electrical and mechanical constants, magnetic flux of magnets among others.

The objectives of the present invention are achieved by means of a control system for electric motors, which is executed in a plurality of electronic converters equipped with at least one digital signal processing stage and one power processing stage, and such control system executes a vector control algorithm that is coupled to a maximization algorithm of the Ampere conjugate, with the objective of finding the smallest current necessary to generate the conjugate to meet a given thermal load of the refrigeration and/or air conditioning system. Once the lowest current to be applied to the motor has been found, the aforementioned energy processing stage, composed of at least one rectifier stage, an intermediate stage containing a filter and an inverter stage, but not limited to this, applies this current to the compressor. hermetic variable speed with permanent magnets on the rotor. The injection of the lowest current necessary for the generation of the electromagnetic conjugate aims to reduce the ohmic losses of the motor, reduce the temperature of the said compressor and, with that, the final objective of this invention is achieved, by maximizing the energy efficiency of the hermetic compressor. for applications in refrigeration systems and air conditioners.

### BRIEF DESCRIPTION OF THE DRAWINGS

The accompanying drawings illustrate the present invention, in which:

FIG. 1 is a simplified block diagram of the system;

FIG. 2 is a block diagram of the electronic converter;

FIG. 3 is a detailed block diagram of the control system; and

FIG. 4 is an MTPA operating curve.

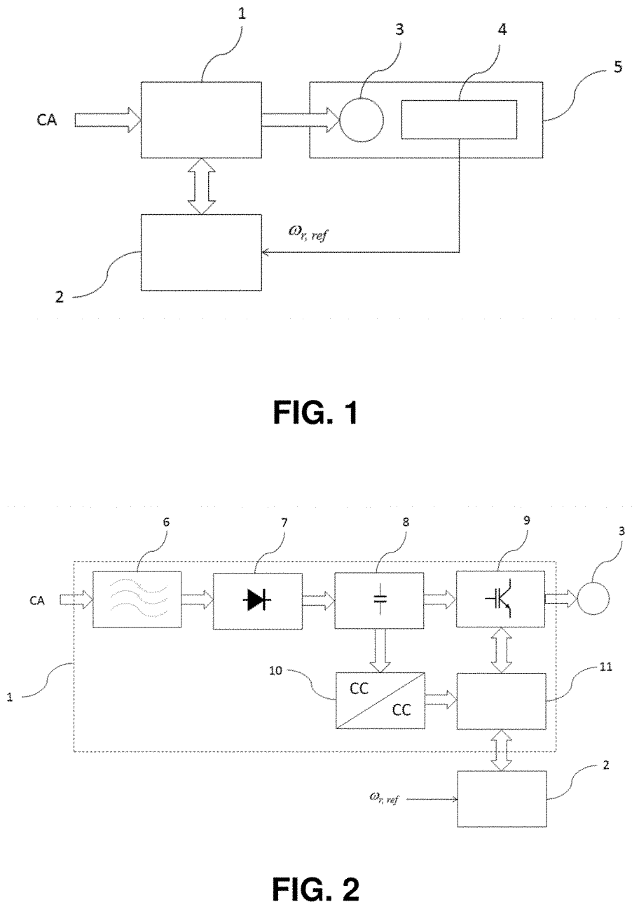

The present invention will now be described in detail through FIGS. 1 to 4, which illustrate preferred, but not mandatory designs, not limited to these, to implement the present invention.

### DETAILED DESCRIPTION

FIG. 1 illustrates the simplified block diagram of the system considered in the present invention, consisting of an electronic converter (1), connected to the AC power distribution network, which, by means of a digital signal processor, performs a control algorithm (2), whose function is to efficiently drive the electric motor, of the PMSM type, which is embedded in the hermetic variable speed compressor (3). Said compressor is part of a plurality of refrigeration systems (5), which can be, but not limited to, refrigerators and freezers for residential or commercial use, “window” type air conditioners (where the evaporator and condenser are in the unit of the equipment) or of the “split” type (where the evaporator and condenser are in different equipment units). In the design illustrated through FIG. 1, the components that make up the cooling system (5) are not shown, such as: evaporator, condenser, filter, and expansion element, among others, as they are not decisive for the purposes of the present invention. However, FIG. 1 highlights an important element of the refrigeration system, which is the thermostat (4), which in this conception is of the electronic type, as opposed to the electromechanical thermostats, being that the referred thermostat (4) is responsible for the temperature control of the cooling system (5), whatever it may be, from a temperature reference indicated by the user. In applications containing hermetic compressors of variable speed, it is necessary to determine a speed reference (ω_{r, ref}) for compressor operation, so that the temperature of the refrigeration system is maintained in accordance with that desired by the user. Once the speed reference is defined, it is made available to the control algorithm (2) for operation of the compressor motor. It is not an object of the present invention to discuss the determination of the compressor operating speed reference.

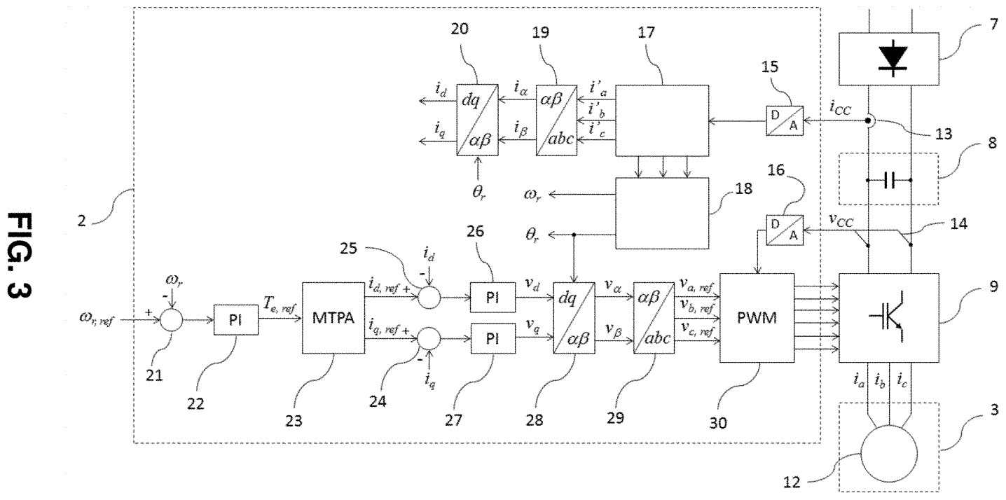

FIG. 2 presents a block diagram of the electronic converter (1) illustrating the minimum elements that comprise it, illustratively, and this conception should not be understood as limiting, in any way, within the scope of the present invention. So, in the design illustrated through FIG. 2, a low-pass filter coupled to the grid (6) is used to minimize the emission of electrical noise from the switched circuits that integrate the electronic converter (1) and, thus, contribute to maintaining the quality of the electricity from the electricity grid. A rectifier circuit (7), connected to the filter outlet (6), is responsible for converting electrical energy into alternating current (AC), coming from the electrical network, into pulsed direct current (DC). The rectifier circuit (7) admits a plurality of constructive variants, which can be single-phase or three-phase, uncontrolled or controlled, or of the synchronous type. Since the rectifier output (7) is a pulsating DC signal, a filter stage (8) is necessary to eliminate the low-frequency pulsation and thus create an oscillation-free DC “bus”. The filter output of the DC bus is used for two purposes, the first being to supply the input of the inverter stage (9) and the second to supply the input of the low voltage DC power supply (10). The inverter stage (9) is a three-phase H bridge type structure, typically used as a voltage source type inverter, but not limited to it, implemented by fast semiconductor switches, such as IGBT or MOSFET transistors, but not limited to them. The inverter (9) is controlled by the digital signal processing stage (11) in an appropriate way to transform the DC voltage at its input, into AC voltage at the output. This AC voltage, whose fundamental component is typically sinusoidal, can be adjusted in amplitude, frequency, and phase to drive the electric motor of the hermetic compressor. An electrical level conversion element, not shown in FIG. 2, is necessary for the connection between the inverter (8) and the digital signal processing stage (11). The DC source (10) is an electronic converter of the CC-DC type, which can be implemented by a multiplicity of topologies, which converts the high DC voltage of the DC bus into low amplitude DC voltages necessary for the operation of the digital signal processor and other low-power circuits not shown in FIG. 2. It is worth mentioning that the connection between the inverter stage (9) and digital signal processing (11) is bidirectional, since in addition to the command signals of the semiconductor switches that make up the inverter (9), voltage and current sensors, not shown in FIG. 2, they are necessary for the operation of the control algorithm (2) which will be detailed in FIG. 3. The signals from these sensors are applied to the analog to digital conversion inputs (A/D converters), which make up the digital signal processor (11).

FIG. 3 presents the detailed block diagram of the control algorithm (2), showing a possible implementation of the present invention, in which a current sensor (13) measures the current of the DC bus (i_{cc}) and a sensor of voltage (14) measures the DC bus voltage (v_{cc}), and the outputs of these sensors are converted to digital values in the A/D converters (15) and (16), respectively. The digital word from (15) is applied to an algorithm to reconstruct the phase currents of the motor (17), which estimates the currents at the motor terminals iₐ, i_{b}, and i_{c} through i_{cc}, since the reading of the A/D (15) is performed in synchronization with the triggering of the semiconductor switches of the inverter bridge (9), so that it is possible to correlate the instantaneous current icc with the phase currents of the motor (12) of the hermetic compressor (3). The output of the algorithm (17), i′ₐ, i′_{b}, and i′_{c}, has two purposes: the first is to provide the input signals for an algorithm to estimate the speed and angular position of the rotor (18), producing in the its output two pieces of information, with ωr being the velocity estimate and θr being the estimate of the angular position of the rotor. The second purpose of (17) is to provide the input signals for the algorithm that performs the Clarke transform, that is, the transformation of a sinusoidal, three-phase and, time-dependent abc coordinate system, to a sinusoidal coordinate system, two-phase, stationary, and time-dependent, known as αβ (19). Together with the estimate of the angular position of the rotor θr, the output of (19) provides the input signals for the algorithm that performs the Park transform, that is, the transformation of a sinusoidal, biphasic, and time-dependent coordinate system, said ab, for a rotating coordinate system, synchronous with the motor current frequency (12), called dq (20). The speed reference ω_{r ref}, produced by the thermostat (4), works as an input command for the control algorithm (2), this signal being compared with the speed estimate w coming from (18) through the error detector (21). The speed error signal is applied to a proportional and integral type controller (22), but not limited to it, whose output is the reference of electromagnetic torque T_{e, ref}, which will be the input of the MTPA algorithm (23). The outputs of (23) are the references for the current controllers i_{d, ref} and i_{q, ref} which will be applied to the error detectors (24) and (25) that compare the references with the current feedback signals i_{d} and i_{q}, coming from (20). The error signals of the direct axis and quadrature currents will be applied to controllers of the proportional and integral type (26) and (27), but not limited to these, whose outputs are applied to algorithms that perform the Park inverse transforms (28) and Clarke (29). The outputs of (29) are again three-phase sine, used as references for Pulse Width Modulation (PWM (30), which generates the trigger signals for the semiconductor switches of the inverter bridge (9).

An important feature of the present invention is the use of the MTPA algorithm in conjunction with the vectorial control of the motor speed which, according to the teachings already described in the present invention and, as known from the state of the art, it is recognized that the conjugate produced by a PMSM is a function of the number of pairs of poles of the motor (P), the magnetic flux (φ_{M}) produced by the rotor magnets and concatenated in the stator windings, in addition to depending on the currents i_{d} and i_{q} and the inductances of the stator in the synchronous referential, (L_{d}) and (L_{q}) respectively, and the conjugate can be represented by the expression (E.1):

Tₑ=3/2·P·[ϕ_{M}·i_{q}+(L_{d}−L_{q})·i_{d}·i_{q}] (E.1)

the first portion being (E.1) called the magnetic conjugate, produced by the magnets and the second portion is called the reluctance conjugate, produced by the protrusions of the rotor, which is a function of its constructive shape. In rotors with magnets inserted in the rotor steel package, as is the case of motors used in variable speed compressors applied in air conditioners, the inductance in the direct axis is less than that of the quadrature axis, analyzing the expression (E.1) this means that a negative id must be entered to maximize the generation of the conjugate. However, the expression (E.1) can be used in another way, that is, the introduction of negative i_{d} reduces the need for i_{q} for the same conjugate. This is the aspect explored in the present invention, that is, the smallest i_{q} necessary to generate the conjugate required by the charge, obtained by introducing a negative i_{d}.

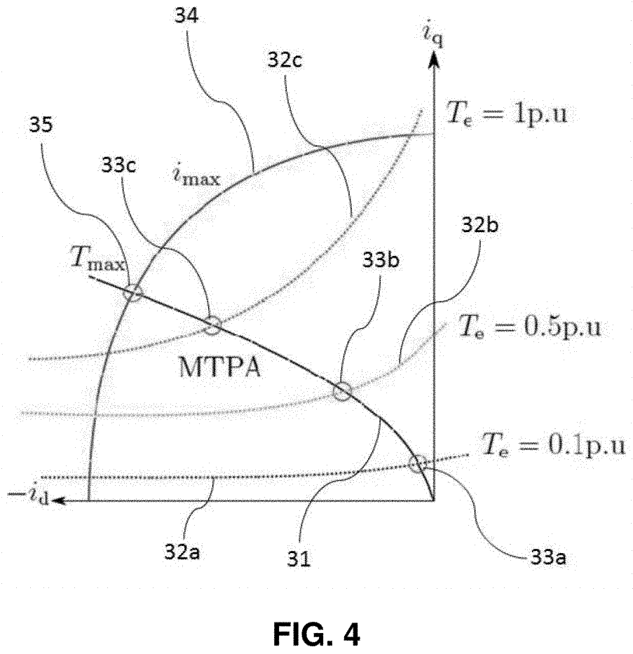

The MTPA concept can be better understood through FIG. 4, which shows a graph of i_{q}×i_{d} in a preferred design, with only the negative portion of the direct axis being represented, since a positive i_{d} is never wanted. The MTPA curve (31) shows the trajectory of the pairs i_{d} and i_{q} that produce the desired conjugate with the smallest possible magnitude of these currents, this curve intercepts constant conjugate curves exemplified by (32a), (32b) and (32c), but not limited to these, so that any pair of i_{d} and i_{q}, on these curves, produces the same conjugate. However, according to the teachings already described in the present invention, there is a unique and particular pair i_{d} and i_{q} that produces the desired conjugate with the smallest possible magnitude of these currents. This pair is given by crossing the curve (31) with the constant conjugate curves, exemplified by the intersections (33a), (33b) and (33c); therefore, it is always preferable to operate the engine as close as possible to the crossing points. Curve (34) exemplifies the maximum current limit for a particular motor, the intersection point (35) being between curves (31) and (34) the maximum point combined with the best efficiency

In a preferential but not mandatory design, the MTPA technique used in this invention is based on the angle (b) of the motor phase current, defined by the expression (E.2):

$$β = {sen}^{- 1} [ \frac{- {∅}_{M} + \sqrt{{∅}_{M}^{2} + 8 \cdot ( {L}_{d} - {L}_{q}^{2} )} + {i}_{s}^{2}}{4 \cdot ( {L}_{d -} {L}_{q} ) \cdot {i}_{s}} ] \qquad ( E .2 )$$

where is the stator current defined by the expression (E.3), with T_{e, ref} calculated by (22):

$${i}_{s} = \frac{{T}_{e , ref}}{\frac{3}{2} \cdot P \cdot {∅}_{M}} \qquad ( E .3 )$$

Once the angle of the MTPA algorithm (23) has been calculated, it will define the optimal references for the pair of currents i_{d} and i_{q} according to the expressions (E.4) and (E.5):

i_{d,ref}=−iₛ·sen(β) (E.4)

i_{d,ref}=−iₛ·COS(β) (E.5)

The present invention proposes a technique to optimize the efficiency of hermetic compressors of variable speed, by means of a vector control technique coupled to the MTPA algorithm, in order to find the lowest excitation current of the motor for the development of the required torque, unlike other inventions that use the MTPA technique to maximize the availability of engine torque; thus, the present invention implies a competitive advantage for the aforementioned electronic converter (1) operating with the control algorithm (2).

The examples and descriptions mentioned in the current invention are merely illustrative and are not to be construed as limiting in any way, within the scope of the invention, according to the claims.

1. A method for increasing the efficiency of hermetic compressors applied in refrigeration and air conditioning, characterized by having an electronic converter, which executes at least one control algorithm to conveniently drive a variable speed hermetic compressor, said compressor being an integral part of a plurality of refrigeration systems, such as refrigerators and freezers for residential or commercial use, window-type or split-type air conditioners.

2. The method for increasing the efficiency of hermetic compressors applied in refrigeration and air conditioners of claim 1, wherein at least one electronic converter, consisting of a power circuit containing at least one rectifier circuit, a DC filter, an inverter circuit and a digital signal processor, which can be implemented by a multiplicity of digital processors.

3. The method for increasing the efficiency of hermetic compressors applied in refrigeration and air conditioners of claim 2, characterized by having a current sensor and a voltage sensor on the DC bus.

4. The method for increasing the efficiency of hermetic compressors applied in refrigeration and air conditioners of claim 2, characterized by having at least one electric motor control algorithm that is performed by the digital signal processor.

5. The method to increase the efficiency of hermetic compressors applied in refrigeration and air conditioners of claim 4, characterized by having an algorithm for controlling the speed of the hermetic compressor's electric motor, being this vector-type algorithm (FOC).

6. The method for increasing the efficiency of hermetic compressors applied in refrigeration and air conditioners of claim 5, characterized by having a second algorithm of the MTPA type, which is responsible for defining the lowest operating current for the compressor hermetic, to supply to a certain conjugate.

7. The method for increasing the efficiency of hermetic compressors applied in refrigeration and air conditioners of claim 6, characterized by having a curve with the trajectory of the best combinations of currents i_{d} and i_{q} to meet a given demand for conjugate.

8. The method for increasing the efficiency of hermetic compressors applied in refrigeration and air conditioners of claim 7, characterized by having a multiplicity of curves of the same conjugate that, when intercepted by the MTPA curve, define the lowest currents i_{d} and i_{q} to operate the hermetic compressor and thus consume the lowest power, maximizing its efficiency over the entire operating speed range and at all load points within the operating envelope delimited by.
